(19) United States
(12) Patent Application Publication
(10) Pub. No.: US 2012/0298135 A1
(43) Pub. Date: Nov. 29, 2012

(54) Toothbrush Having Removable Absorbent Pad

(76) Inventors: Lindsay G. Luttrell, Knoxville, TN (US); Bradley J. Luttrell, Knoxville, TN (US)

(21) Appl. No.: 13/480,428

(22) Filed: May 24, 2012

Related U.S. Application Data
(60) Provisional application No. 61/490,251, filed on May 26, 2011.

(51) Int. Cl. A46B 9/04; B08B 1/00; A47L 13/12; A47L 13/17; A47L 13/16

(52) U.S. Cl. 134/6; 15/114; 15/104.94; 15/244.4; 15/210.1

(57) ABSTRACT

An oral care device is provided. The oral care device includes a toothbrush and an absorbent pad. The toothbrush has an elongated shaft having a proximal end and a distal end. The proximal end defines a handle for a user. The toothbrush also includes a plurality of bristles at the distal end. The bristles are dimensioned to enter the mouth of a human user. The pad has an outer circumference or edge. The pad further has an interior through-opening for frictionally and removably receiving the shaft of the toothbrush. The pad is fabricated at least along its circumference from an absorbent material. A method for brushing one's teeth using a toothbrush with a pad is also provided.

### CROSS REFERENCE TO RELATED APPLICATIONS

This application claims the benefit of U.S. Ser. No. 61/490,251 filed May 26, 2011. That application is entitled “Toothbrush Having Replaceable Absorbent Pad.” That application is incorporated herein by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

1. Field of the Invention

The present invention relates to oral care devices. More specifically, the invention relates to toothbrushes and other oral hygiene implements having an elongated shaft.

2. Technology in the Field of the Invention

The benefits of oral hygiene are well documented. Regular brushing of one's teeth helps to control plaque and tartar. These can result in bad breath, gum inflammation and dental caries, also known as tooth decay. In some instances, poor dental hygiene can lead to loss of one or more teeth, infection, or both.

A diverse array of manual and automated tooth and gum cleansing devices have been developed. These include electric toothbrushes, oral irrigators, and automated flossers. U.S. Pat. No. 8,176,590 provides an example of an oscillating toothbrush designed to assist an individual in brushing their teeth. Specialty toothbrushes have been generally marketed directly to the consumer as an aid in oral hygiene.

The above devices are useful for adults. However, children, particularly children under the age of seven, are not responsible enough or coordinated enough to use electric or hydraulic oral care devices. Accordingly, small children are confined to using traditional manual toothbrushes.

Manual brushes still require the user to have a minimum degree of manual dexterity, particularly in attempting to achieve proper brushing techniques. However, small children are prone to having water, saliva, and toothpaste move down the shaft of the toothbrush through a combination of gravity and surface tension. Such residual fluids may ultimately fall to the floor, fall onto the child's hand, or fall onto a bathroom counter. This produces a messy if not unsanitary condition.

Accordingly, a need exists for a toothbrush having an absorbent pad that captures residual fluids as they travel down the shaft of the toothbrush. Further, a need exists for a toothbrush that may be set down upon a counter without the bristles touching the counter. Still further, a need exists for an oral care device wherein water and saliva are captured before reaching the user's hand.

### BRIEF SUMMARY OF THE INVENTION

An oral care device is provided herein. The oral care device is preferably a toothbrush, although it may be a gum massager, a so-called water-pic, and so forth.

In one embodiment, the toothbrush (or other oral care device) has an elongated shaft with a proximal end and a distal end. The proximal end defines a handle for a user.

The toothbrush also includes a plurality of bristles at the distal end. The bristles are dimensioned to enter the mouth of the user. Preferably, the user is a small child. However, the user could also be an adult who is the victim of a stroke or muscular dystrophy or other condition producing limited dexterity.

The toothbrush further includes a pad. The pad has an outer circumference or edge. The pad further has an interior through-opening for frictionally receiving the shaft of the toothbrush.

In accordance with the present inventions, the pad is fabricated along the circumference of the toothbrush from an absorbent material. Preferably, the pad is further fabricated from an elastic material adjacent the through-opening. In one aspect, the absorbent pad includes an anti-microbial material. A natural scent such as peppermint oil or cinnamon oil may also be included.

### BRIEF DESCRIPTION OF THE DRAWINGS

So that the manner in which the present invention can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an oral care device of the present invention, in one embodiment.

FIG. 2 is a side, cross-sectional view of the pad of the oral care device of FIG. 1.

FIG. 3 is a perspective view of an oral care device in an alternate embodiment. Here, a tulip-shaped pad is used. The pad is supporting the bristles of the toothbrush above a counter surface.

FIG. 4A is a perspective view of an absorbent pad as may be used with the oral care device of FIG. 1, in an alternate embodiment. Here, the pad has a star-shaped stepped surface.

FIG. 4B is a perspective view of an absorbent pad as may be used with the oral care device of FIG. 1, in another alternate embodiment. Here, the pad has a heart-shaped stepped surface.

### DETAILED DESCRIPTION

### Definitions

As used herein, the term “absorbent material” means a material possessing the ability to absorb oral fluids. Non-limiting examples of absorbent material include cotton, oat fibers, psyllium husk fiber, and airlaid, nonwoven material.

### DETAILED DESCRIPTION OF CERTAIN EMBODIMENTS

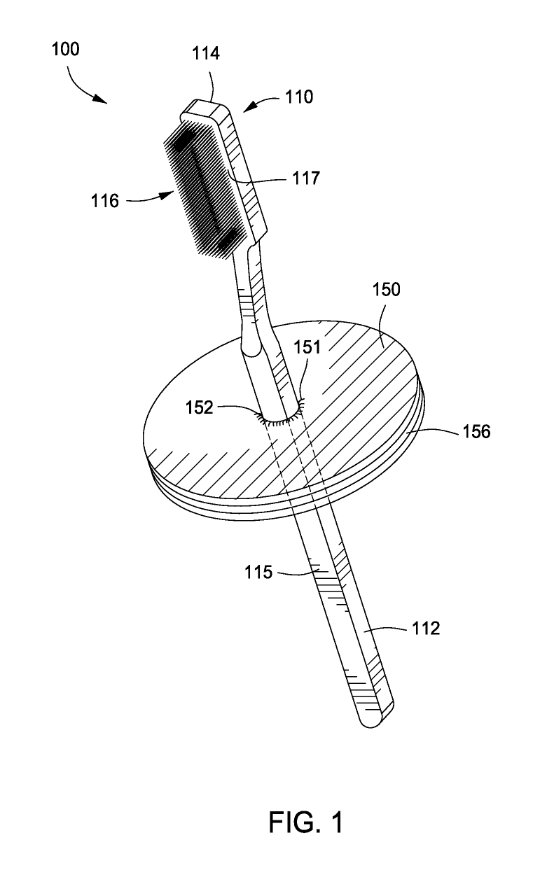

FIG. 1 provides a perspective view of an oral care device 100 of the present invention, in one embodiment. The oral care device includes a hygienic tool 110 and a pad 150.

The hygienic tool may be a gum massager, a pick, a toothbrush, or other dental implement. In the illustrative view of FIG. 1, the hygienic tool 110 is a toothbrush. The hygienic tool 110 has an elongated shaft 115. The shaft 115 has a proximal end 112 which defines a handle for a user.

The shaft 115 also has a distal end 114. The distal end 114 provides a plurality of bristles 116. The bristles 116 are arranged in tufts extending from a face 117 of the distal end 114. The bristles 116 are dimensioned to enter the mouth of the user. Preferably, the user is a small child. In one aspect though, the user is an adult who has suffered a stroke or neurological damage and has limited dexterity.

Generally, toothbrush bristles are filaments of a polymeric material such as the well known Tynex™ bristles made of nylon. Toothbrush bristles may have a circular cross section, although bristles having a triangular cross-section are also known. Triangular cross-section bristles have the advantage that they can penetrate the interproximal spaces between the teeth better than circular section tufts. Triangular bristles can also be packed together more densely than circular sectioned bristles, as triangular shapes fit together without the interstitial voids that form between packed circular shapes. However, the present inventions are not limited by the characteristics of the bristles 116 unless expressly stated in the claims, below.

As noted, the oral care device 100 also includes a pad 150. The pad 150 has an outer edge or circumference 155. The pad 150 also has an interior through-opening 152 for frictionally and removably receiving the shaft 115 of the toothbrush 110.

The pad 150 is primarily fabricated from an absorbent material. The absorbent material may be a natural material such as cotton or wood pulp. Alternatively, the absorbent material may be fabricated from synthetic fibers, or a mixture of cellulosic and synthetic fibers. In this instance, the pad 150 is preferably formed as a substrate from airlaid, non-woven fibers held together by a binding agent. Alternatively still, the pad 150 may be a natural or synthetic sponge material.

In one embodiment, a portion of the pad 150 immediately around the through-opening 152 is fabricated from an elastic material. This portion, shown at 151, provides an element of elasticity to the through-opening 152. This, in turn, enables the pad 150 to frictionally hold the shaft 115 of the toothbrush 110.

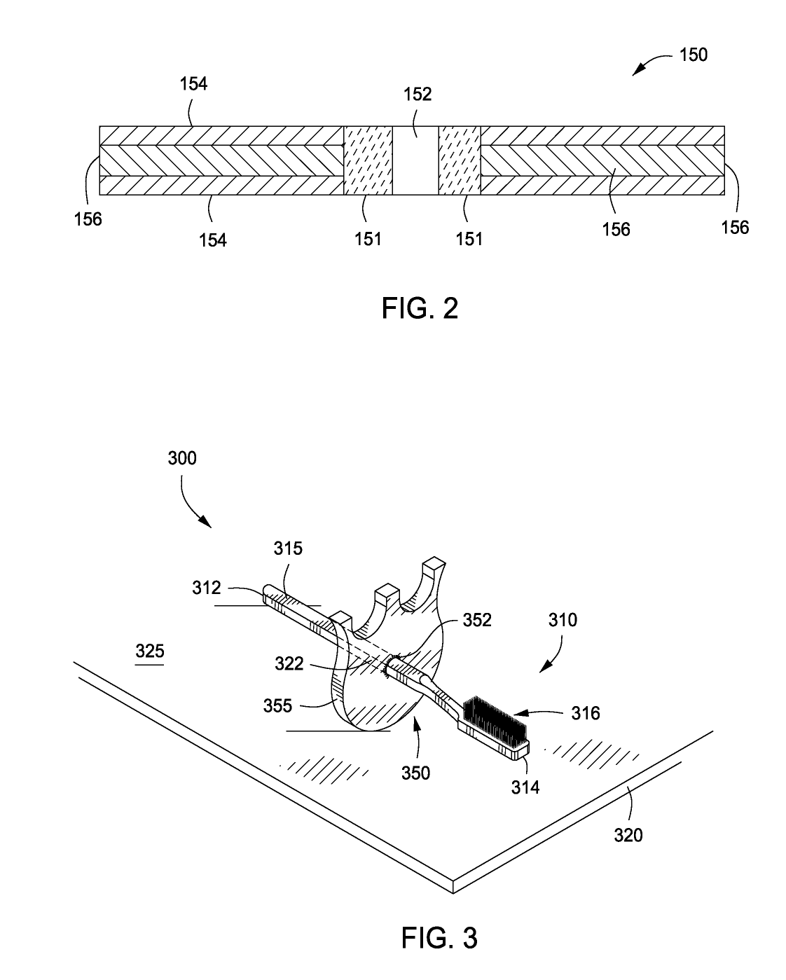

FIG. 2 presents a side, cross-sectional view of the pad 150 of the toothbrush assembly 100 of FIG. 1. Certain features of the pad 150 are more clearly seen. First, the through-opening 152 is visible in the center of the pad 150. Around the through-opening 152 is the optional elastic material 151.

Outer surfaces 154 are also seen. The outer surfaces 154 are designed to absorb saliva and water. Preferably, the material making up the absorbent outer surfaces 154 is cellulosic fibers, or a mixture of cellulosic and synthetic fibers.

A wide variety of natural and synthetic fibers are suitable for use as matrix fibers for the outer surfaces 154. Preferred matrix fibers are cellulosic fibers, though matrix fibers may also be synthetic fibers. Cellulosic fibrous materials suitable for use in the pad 150 include both softwood fibers and hardwood fibers. See M. J. Kocurek & C. F. B. Stevens, Pulp and Paper Manufacture—Vol. 1: Properties of Fibrous Raw Materials and Their Preparation for Pulping, The Joint Textbook Committee of the Paper Industry, pp. 182 (1983), which is hereby incorporated by reference in its entirety.

Desirably, the cellulosic fiber for use as a matrix fiber has been derived from a source which is one or more of Southern Softwood Kraft, Northern Softwood Kraft, hardwood, eucalyptus, and pre- and post-consumer recycled wood fibers. Southern Softwood Kraft is most preferred.

Exemplary, though not exclusive, types of softwood pulps are derived from slash pine, jack pine, radiata pine, loblolly pine, white spruce, lodgepole pine, redwood, and Douglas fir. North American southern softwoods and northern softwoods may be used, as well as softwoods from other regions of the world. Hardwood fibers may be obtained from oaks, genus Quercus, maples, genus Acer, poplars, genus Populus, or other commonly pulped species. In general, softwood fibers are preferred due to their longer fiber length as measured by T 233 cm-95, and southern softwood fibers are most preferred due to a higher coarseness as measured by T 234 cm-84, which leads to greater intrinsic fiber strength as measured by breaking load relative to either northern softwood or hardwood fibers.

One particularly suitable cellulose fiber is bleached Kraft southern pine fibers sold under the trademark FOLEY FLUFFS® (Buckeye Technologies Inc., Memphis, Tenn.). Other options include cotton linter pulp, chemically modified cellulose such as cross-linked cellulose fibers and highly purified cellulose fibers, such as Buckeye HPF, each available from Buckeye Technologies Inc. of Memphis, Tenn. Other suitable cellulose fibers include those derived from Esparto grass, bagasse, jute, ramie, kenaff, sisal, abaca, hemp, flax and other lignaceous and cellulosic fiber sources.

The fibrous material may be prepared from its natural state by any pulping process including chemical, mechanical, thermomechanical (TMP) and chemithermomechanical (CTMP) pulping. These industrial processes are described in detail in R. G. Macdonald & J. N. Franklin, Pulp and Paper Manufacture in 3 Volumes; 2^{nd} Edition, Volume 1: The Pulping of Wood, 1969; Volume 2: Control, Secondary Fiber, Structural Board, Coating, 1969, Volume 3: Papermaking and Paperboard Making, 1970, The joint Textbook Committee of the Paper Industry, and in M. J. Kocurek & C. F. B. Stevens, Pulp and Paper Manufacture, Vol. 1: Properties of Fibrous Raw Materials and Their Preparation for Pulping, The Joint Textbook Committee of the Paper Industry, p. 182 (1983), both of which are hereby incorporated by reference in their entirety. Preferably, the fibrous material is prepared by a chemical pulping process, such as a Kraft or sulfite process. The Kraft process is especially preferred.

Pulp prepared from a Southern softwood by a Kraft process is often called SSK. In a similar manner, southern hardwood, northern softwood and northern hardwood pulps are designated SHK, NSK & NHK, respectively. Bleached pulp, which is fibers that have been delignified to very low levels of lignin, are preferred, although unbleached Kraft fibers may be preferred for some applications due to lower cost, especially if alkaline stability is not an issue. Thermomechanical cellulose fiber may be used. Desirably, the cellulose fiber for use as a matrix fiber has been derived from a source which is one or more of Southern Softwood Kraft, Northern Softwood Kraft, hardwood, eucalyptus, mechanical, recycle and rayon, but preferably Southern Softwood Kraft, Northern Softwood Kraft, or a mixture thereof, and more preferably, Southern Softwood Kraft.

Another cellulosic material that may be used for the absorbent outer surfaces 154 is psyllium husk fiber. Pysillium husk fibers are known to have absorbing and/or expanding properties when placed into contact with oral fluids. Other absorbent materials include cotton and oat fibers.

The cellulose or fluff fibers may be blended with synthetic fibers such as polyester, nylon, polyethylene or polypropylene. Alternatively, only synthetic fibers may be employed in the pad 150. Synthetic fibers suitable for use as a matrix fiber include cellulose acetate, polyolefins (including polyethylene and polypropylene), nylon, polyester (including polyethylene terephthalate (PET)), vinyl chloride, and regenerated cellulose such as viscose rayon, and the various bicomponent fibers known in the art of non-woven substrates.

Other synthetic fibers suitable for use in various embodiments as matrix fibers for the pad 150 include fibers made from various polymers including, by way of example and not by limitation, acrylic, polyamides (such as, for example, Nylon 6, Nylon 6/6, Nylon 12, polyaspartic acid, polyglutamic acid, and so forth), polyamines, polyimides, polyacrylics (such as, for example, polyacrylamide, polyacrylonitrile, esters of methacrylic acid and acrylic acid, and so forth), polycarbonates (such as, for example, polybisphenol carbonate, polypropylene carbonate, and so forth), polydienes (such as, for example, polybutadiene, polyisoprene, polynorbornene, and so forth), polyepoxides, polyesters (such as, for example, polyethylene terephthalate, polybutylene terephthalate, polytrimethylene terephthalate, polycaprolactone, polyglycolide, polylactide, polyhydroxybutyrate, polyhydroxyvalerate, polyethylene adipate, polybutylene adipate, polypropylene succinate, and so forth), polyethers (such as, for example, polyethylene glycol (polyethylene oxide), polybutylene glycol, polypropylene oxide, polyoxymethylene (paraformaldehyde), polytetramethylene ether (polytetrahydrofuran), polyepichlorohydrin, and so forth), polyfluorocarbons, formaldehyde polymers (such as, for example, urea-formaldehyde, melamine-formaldehyde, phenol formaldehyde, and so forth), natural polymers (such as, for example, cellulosics, chitosans, lignins, waxes, and so forth), polyolefins (such as, for example, polyethylene, polypropylene, polybutylene, polybutene, polyoctene, and so forth), polyphenylenes (such as, for example, polyphenylene oxide, polyphenylene sulfide, polyphenylene ether sulfone, and so forth), silicon containing polymers (such as, for example, polydimethyl siloxane, polycarbomethyl silane, and so forth), polyurethanes, polyvinyls (such as, for example, polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone, and so forth), polyacetals, polyarylates, and copolymers (such as, for example, polyethylene-co-vinyl acetate, polyethylene-co-acrylic acid, polybutylene terephthalate-co-polyethylene terephthalate, polylauryllactam-block-polytetrahydrofuran, and so forth).

The matrix fibers desirably are present in the pad 150 in an amount of from about 30 percent by weight to about 95 percent by weight based on the total weight of the material, more desirably, from about 55 percent to about 90 percent by weight based on the total weight of the material, and more preferably in an amount of about 75 percent by weight to about 95 percent by weight.

The outer surfaces 154 may optionally include a binder. Binders suitable for use in the nonwoven material may be various bicomponent binder fibers or mixtures thereof, various latices or mixtures thereof, or bicomponent fibers or mixtures thereof in combination with various latices or mixtures thereof, which may be thermoplastic, thermosetting or a mixture thereof. Thermoplastic powders may be used in various embodiments, and may be included in a nonwoven substrate as a fine powder, chip or in granular form. In addition, binders having dense fine powder filler such as, for example, calcium carbonate, various kinds of clay, such as, for example, bentonite and kaolin, silica, alumina, barium sulfate, talc, titanium dioxide, zeolites, cellulose-type powders, diatomaceous earth, barium carbonate, mica, carbon, calcium oxide, magnesium oxide, aluminum hydroxide, pulp powder, wood powder, polymer particles, chitin and chitin derivatives are suitable for use in forming the substrate.

Various latex binders are suitable for use in the absorbent material making up the pad 150 when the pad 150 is fabricated from a non-woven material. Examples include ethyl vinyl acetate copolymers such as AirFlex 124® offered by Air Products of Allentown, Pa. AirFlex 124® is used with 10 percent solids and 0.75 percent by weight AEROSOL® OT which is an anionic surfactant offered by Cytec Industries of West Paterson, N.J. Other classes of emulsion polymer binders such as styrene-butadiene and acrylic binders may also be used. BINDERS AIRFLEX® 124 and 192 from Air Products, Allentown, Pa., optionally having an opacifier and whitener, such as, for example, titanium dioxide, dispersed in the emulsion may be used. Other classes of emulsion polymer binders such as styrene-butadiene, acrylic, and carboxylated styrene butadiene acrylonitrile (SBAN) may also be used. A carboxylated SBAN is available as product 68957-80 from Dow Reichhold Specialty Latex LLC of Research Triangle Park, N.C.

The Dow Chemical Company of Midland, Michigan is a source of a wide variety of suitable latex binders, such as, for example, Modified Styrene Butadiene (S/B) Latexes CP 615NA and CP 692NA, and Modified Styrene Acrylate (S/A) Latexes, such as, for example, CP6810NA. A wide variety of suitable latices are discussed in Emulsion Polymers, Mohamed S. El-Aasser (Editor), Carrington D. Smith (Editor), I. Meisel (Editor), S. Spiegel (Associate Editor), C. S. Kniep (Assistant Editor), ISBN: 3-527-30134-8, from the 217th American Chemical Society (ACS) Meeting in Anaheim, Calif. in March 1999, and in Emulsion Polymerization and Emulsion Polymers, Peter A. Lovell (Editor), Mohamed S. El-Aasser (Editor), ISBN: 0-471-96746-7, published by Jossey-Bass, Wiley. Also useful are various acrylic, styrene-acrylic and vinyl acrylic latices from Specialty Polymers, Inc., 869 Old Richburg Rd., Chester, S.C. 26706. Also useful are Rhoplex™ and Primal™ acrylate emulsion polymers from Rohm and Haas.

Bicomponent fibers having a core and sheath are known in the art. Many varieties are used in the manufacture of non-woven materials, particularly those produced by airlaid techniques. Various bicomponent fibers suitable for use in the present invention are disclosed in U.S. Pat. Nos. 5,372,885 and 5,456,982, both of which are hereby incorporated by reference in their entirety. Examples of bicomponent fiber manufacturers include KoSa (Salisbury, N.C.), Trevira (Bobingen, Germany) and ES Fiber Visions (Athens, Ga.).

Bicomponent fibers may incorporate a variety of polymers as their core and sheath components. Bicomponent fibers that have a PE (polyethylene) or modified PE sheath typically have a PET (polyethyleneterephthalate) or PP (polypropylene) core. In one embodiment, the bicomponent fiber has a core made of polyester and sheath made of polyethylene. The denier of the fiber preferably ranges from about 1.0 dpf to about 4.0 dpf, and more preferably from about 1.5 dpf to about 2.5 dpf. The length of the fiber is preferably from about 3 mm to about 12 mm, more preferably from about 4.5 mm to about 7.5 mm.

In one aspect, the absorbent material making up the pad 150 has a basis weight of from about 35 gsm to about 1,000 gsm or, alternatively, has a basis weight of from about 35 gsm to about 500 gsm or, alternatively still, has a basis weight of from about 35 gsm to about 250 gsm. In another aspect, the absorbent material making up the pad 150 has a basis weight of from about 100 gsm to about 1,000 gsm or, alternatively, has a basis weight of from about 250 gsm to about 1,000 gsm or, alternatively still, has a basis weight of from about 500 gsm to about 1,000 gsm.

In another aspect, the material of the absorbent outer surfaces 154 of the pad 150 has a basis weight of from about 35 gsm to about 500 gsm and contains from about 30 weight percent to about 95 weight percent matrix fibers and from about 5 weight percent to about 70 weight percent of a binder where the weight percentages are based on the total weight of the nonwoven substrate. Optionally, the absorbent material making up the pad 150 may contain from about 50 weight percent to about 95 weight percent matrix fibers and from about 5 weight percent to about 50 weight percent of a binder.

In one embodiment, the material of the absorbent outer surfaces 154 of the pad 150 has a density of from about 0.035 g/cm³ to about 0.10 g/cm³.

The outer surfaces 154 are placed on opposing sides of a substrate 156. The substrate 156 provides stiffness or body to the pad 150, allowing it to maintain shape and to better perform its function of absorbance. The substrate may be a thick scrim. The term “scrim” means any fibrous woven or non-woven layer of material.

The substrate 156 may be used as a carrier sheet in an airlaid process, or may be combined with a pre-formed airlaid or other non-woven material in a converting process. A wide variety of non-woven scrims may be made from natural fibers such as cellulose fibers. Synthetic fibers of various sorts which are spun-bonded, meltblown or spunlaced may also be used. A wide variety of materials including, cloth, textile, and other woven materials made of various natural fibers, synthetic fibers and mixtures thereof may further be used as carriers. Examples are 3024 cellulosic carrier tissue, 18 gsm, from Cellu Tissue Co., now Cellu Tissue Neenah, 249 N. Lake Street, Neenah, Wis. 54956, needle-punched nonwoven fabrics, spun-bonded polypropylene nonwovens, such as Hybond™, a spun-laid thermal-bonded soft fabric available in basis weights from 14 gsm to 20 gsm and ULTRATEX™, a spun-laid (continuous filament) thermal-bonded polypropylene nonwoven in basis weights of 20, 40, 50, 60, 70, 100, 120, and 150 gsm, from Texbond S.P.A., Via Fornaci 15/17, 38068 Rovereto, Italy. Polyester spun-bond nonwovens, with a uniform surface, high tear strength and high porosity, can be used. Polyester spun-bond, which is a manufactured sheet of randomly orientated polyester filaments bonded by calendaring, needling, chemically or a combination of these methods in basis weights from 15 to 500 g/m² is available from Johns Manville Sales GmbH, Max-Fischer-Strasse 11, 86399 Bobingen, Germany.

In general the substrate 156 may be formed via the spun-bond process, the melt-blown process, the spunlaced process, the carding process or a combination of any of these processes, such as, for example, spunbond—melt-blown—spunbond or spunbond—meltblown—meltblown—spunbond. Of interest also are other useful materials such as those where the scrim 156 is made of a polyester, such as, for example, polyethylene terephthalate, polytrimethylene terephthalate and so forth, a polyolefin, such as, for example, polyethylene, polypropylene and so forth, polylactic acid, nylon or a combination of these materials.

The substrate 156 may have a basis weight of from about 8 gsm to about 200 gsm. Alternatively, the scrim may have a basis weight of from about 8 gsm to about 100 gsm, more desirably, from about 8 gsm to about 75 gsm.

The substrate 156 may be a thin layer of synthetic sponge or sponge-like material. However, it is preferred that the substrate 156, or scrim, be sufficiently dense as to limit absorbency. The denser substrate 156 or scrim also helps the pad 150 hold its shape, even when wet. This, in turn, allows the toothbrush 110 to be laid on a counter in such a manner that the bristles 116 themselves do not contact the counter surface.

In one aspect, the substrate 156 is fabricated from a food quality paperboard such as Signature Solutions NuBrite LBW033 (8 mil bleached linerboard with basis weight of 33#/3 msf) available from Georgia-Pacific Corporation. Where potentially absorbent materials such as paperboard are used, a moisture barrier may be formed by coating each side of the scrim 156 with a polymer or poly-laminate. In some embodiments, stiffer materials may be used including heavier paperboards, polystyrene paper, or closed-cell foam board. Where such materials are inherently non-absorbent, no barrier coating is needed.

An adhesive (not shown) may be applied between the outer absorbent surface 154 and the inner scrim 156 for bonding. The adhesive may be, for example, microsphere acrylic adhesives such as TM-55 available from Technicote, Inc. or as used on Post-it Notes as available from 3M Corp. This is a low-tack adhesive that is easy to work with and is inexpensive.

It is noted that the use of a substrate is optional. In one aspect, the pad 150 defines a homogenous absorbent material. The absorbent material may be any of the cellulosic or synthetic matrix fibers described above. Alternatively, the pad 150 may be fabricated from a sponge. The sponge may be either open-cell or closed-cell. Preferably, the sponge is a synthetic sponge fabricated from natural materials. For example, the sponge may comprise a combination of wood pulp (cellulose), sodium sulphate crystals, and hemp fibers. The sponge has an attribute of stiffness when dry, but may be wetted and squeezed out for cleaning between uses.

Preferably, the pad 150 is coated with or otherwise contains an anti-microbial agent. An anti-microbial agent inhibits the risk of spreading infections. Suitable anti-microbial substances include those available from suppliers such as Aegis Environmental Management, Inc. and Microban International, Ltd, as well as others known in the art. Anti-microbial substances may be applied through a variety of methods including, without limitation, using a flexographic printing press and subsequent curing in an oven or by ultraviolet radiation, or simply by spraying the substance onto the absorbent outer surfaces 154 during manufacture.

The anti-microbial agent may be, for example, any of the peptides disclosed in U.S. Pat. No. 7,713,927, entitled “Antimicrobial Peptides.” The '927 patent states that the listed peptides are effective in eradicating streptococcus mutans, which are a common oral pathogen and the causative agent of dental caries. The '927 patent is incorporated herein in its entirety.

Other anti-microbial agents may be employed. For example, the anti-microbial agents may include submicron sized metal particles averaging less than 0.50 microns, wherein the metal is in a base of polysynthetic oils or is applied as part of a colloidal mixture. The metals may be micronized or submicron sized metal that is 99.9% pure and that is comprised of any of the following including; silver, gold, copper, platinum, and/or organo/inorgano complexes of silver, gold, copper, platinum, aluminum oxide, zinc oxide, boron trinitride and metal or metal oxide. The organo/inorgano complexes may include colloidal metals. Any of such metals are believed to eliminate the growth of bacterial organisms.

Another example of a suitable anti-microbial agent is a mixture of silver salt and a biguanide. Biguanide (PHMB) is the generic name of one of the more popular non-chlorine, non-bromine chemical sanitizers used in swimming pools. The advantage PHMB is that no chlorine or bromine is required and there is little chemical odor. Biguanide is also an effective bactericide. Of interest, biguanide has also been used as an anti-malarial drug.

FIG. 3 is a perspective view of an oral care device 300, in an alternate embodiment. The oral care device 300 is like the assembly 100 of FIG. 1. In this respect, the oral care device 300 includes a toothbrush 310 and a pad 350. In FIG. 3, the oral care device 300 has been placed on a counter 320. More specifically, the oral care device 300 is resting on a surface 325 of the counter 320.

As with toothbrush 110, toothbrush 310 has an elongated shaft 315. The shaft 315 has a proximal end 312 that defines a handle for a user. The shaft 315 also has a distal end 314. The distal end 314 provides a plurality of bristles 316. The bristles 316 are dimensioned to enter the mouth of the user. Preferably, the user is a small child.

The toothbrush assembly 300 also includes a pad 350. Here, the pad 350 is shaped like a tulip. The tulip-shaped pad 350 has a through-opening 352 and a circumference 355.

In the view of FIG. 3, the through-opening 352 of the pad 350 has received the shaft 315 of the toothbrush 310. The pad 350 is placed along the shaft 315 in such a manner that the distal end 312 will rest on the counter surface 325. To do this, the pad 350 must be placed along the shaft in such a manner that the pad 350 is closer to the bristles 316 than it is to a center-point of weight 322 for the toothbrush 310.

The pad 350 may optionally comprise printing or embossing for aesthetic purposes. Embossing absorbent materials is known in the art and is often accomplished by compressing a portion of the absorbent outer surfaces (such as those seen at 154 in FIG. 2) so that the surrounding areas are thicker or thinner. Alternatively, the outer surfaces 154 may simply be cut into shapes and adhered onto a stiffened scrim 156.

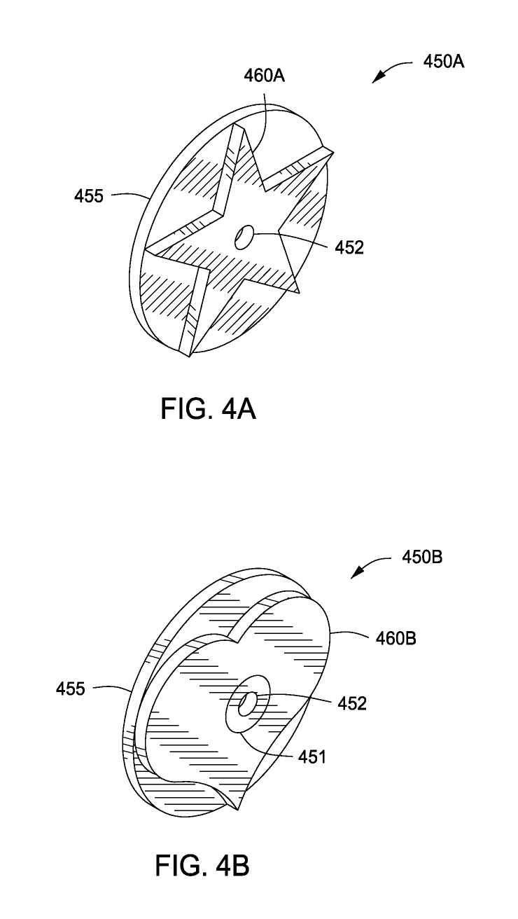

FIG. 4A and FIG. 4B each provides a perspective view of an absorbent pad as may be used with the toothbrush of FIG. 1. In FIG. 4A a first pad 450A is shown, while in FIG. 4B a second pad 450B is shown. Each pad 450A, 450B has an outer circumference 455 and an inner through-opening 452. An optional elastic portion 451 is shown in FIG. 4B.

Each pad 450A, 450B has a respective raised surface 460A, 460B. In the pad 450A of FIG. 4A, the raised surface 460A has the form of a five-pointed star; in the pad 450B of FIG. 4B, the raised surface 460B has the form of a heart. It is understood that numerous other shapes may be placed onto a pad as a raised surface, including, for example, sea shells, puppy paws, cat paws, airplanes, castles, flags, butterflies, and so forth. Further, a pad may actually take a geometrical shape as the outer circumference 155, or be shaped as, for example, a superhero or a dinosaur. Alternatively, the pad may have a design that is embedded into or printed onto the surface of the pad, such as an animal, a cartoon character, a fish, or a dinosaur.

Of benefit, any of the pads 450A, 450B may be removed from the shaft 115 of a toothbrush 110, and replaced. The pads are disposable, breathable and fast drying. In one aspect, the pads 450A, 450B (or pads 150 or 350) have a sufficient stiffness to support the weight of the distal end of the toothbrush when (i) the pad is placed along the shaft at a position closer to the distal end than a center-point of the toothbrush's weight, and (ii) the toothbrush rests or is placed on a counter surface. This is shown in FIG. 3.

The pads may be sold individually without a connected toothbrush. Alternatively, pads may be sold with a toothbrush as a kit. In either instance, the pads are preferably made of an anti-microbial non-woven material that captures moisture while a child brushes his or her teeth, creating a cleaner, healthier environment for the toothbrush—and for the child's mouth. The pads may be scented using, for example, peppermint oil, cinnamon oil, menthol, wintergreen oil, citrus oil, clove oil, and the like.

In one aspect, pads may be sold as a package of, for example, three, four, five, six, or more. In one aspect, the pads are compressed together in a package. In one aspect, the pads are fabricated from a material that swells when wetted. The pads are sold in a dry, compressed, amorphous condition, but then and expands into a given shape when wetted.

While it will be apparent that the inventions herein described are well calculated to achieve the benefits and advantages set forth above, it will be appreciated that the inventions are susceptible to modification, variation and change without departing from the spirit thereof.

I claim:

1. An oral care device, comprising:
a dental hygiene tool comprising an elongated shaft, the shaft having a proximal end defining a handle, and a distal end, and
a disposable pad having an outer circumference and an interior through-opening for removably receiving the shaft of the toothbrush, the pad being fabricated at least partially from an absorbent material.

2. The oral care device of claim 1, wherein:
the dental hygiene tool is a toothbrush;
the distal end of the toothbrush has a plurality of a plurality of bristles, said bristles being dimensioned to enter the mouth of a user; and
the pad is frictionally received over the shaft of the toothbrush.

3. The oral care device of claim 2, wherein the pad is further fabricated from an elastic material adjacent the through-opening.

4. The oral care device of claim 2, wherein the outer circumference defines either a circular profile or a polygonal profile.

5. The oral care device of claim 4, wherein the pad has sufficient stiffness to support the weight of the distal end of the toothbrush when (i) the pad is placed along the shaft at a position closer to the distal end than a center-point of the toothbrush's weight, and (ii) the toothbrush rests on a counter surface.

6. The oral care device of claim 5, wherein the pad comprises:
a substrate having a first density;
a first outer surface on a first side of the substrate having a second density; and
a second outer surface on a second opposing side of the substrate also having a second density.

7. The oral care device of claim 6, wherein the second density is greater than the first density.

8. The oral care device of claim 6, wherein the substrate is substantially non-absorbent.

9. The oral care device of claim 6, wherein:
the substrate is absorbent; and
the pad further comprises a barrier film applied to the substrate to limit absorbency.

10. The oral care device of claim 6, wherein the first and second outer surfaces are fabricated substantially from a cellulosic material.

11. The oral care device of claim 6, wherein the first and second outer surfaces are fabricated substantially from a non-woven airlaid material.

12. The oral care device of claim 11, wherein the first and second outer surfaces comprise an anti-microbial agent.

13. The oral care device of claim 6, wherein the substrate is fabricated from paperboard, polystyrene paper, or closed-cell foam board.

14. The oral care device of claim 6, wherein the first outer surface, the second outer surface, or both are shaped as a star or a heart.

15. The oral care device of claim 5, wherein the pad is substantially homogenous in composition.

16. The oral care device of claim 15, wherein the pad is fabricated from a natural or synthetic sponge material or a closed-cell foam.

17. The oral care device of claim 5, wherein the pad comprises an anti-microbial agent.

18. A disposable absorbent pad comprising:
a substantially planar body having an outer circumference, the body being fabricated at least in part by an absorbent material; and
a through-opening, the through-opening being dimensioned to frictionally and removably receive a shaft of a toothbrush;
wherein the pad has sufficient stiffness to support the weight of the distal end of the toothbrush when (i) the pad is placed along the shaft at a position closer to the distal end than a center-point of the toothbrush's weight, and (ii) the toothbrush rests on a counter surface.

19. The pad of claim 18, wherein the body is further fabricated from an elastic material adjacent the through-opening.

20. The pad of claim 18, wherein the outer circumference defines either a circular profile or a polygonal profile.

21. The pad of claim 18, wherein the body comprises:
a scrim having a first density;
a first outer surface on a first side of the scrim having a second density; and
a second outer surface on a second opposing side of the scrim also having a second density.

22. The pad of claim 21, wherein the second density is greater than the first density.

23. The pad of claim 21, wherein the substrate is substantially non-absorbent.

24. The pad of claim 21, wherein the first and second outer surfaces are fabricated substantially from a cellulosic material.

25. The pad of claim 21, wherein the first and second outer surfaces are fabricated substantially from a non-woven airlaid material.

26. The pad of claim 25, wherein the first and second outer surfaces comprise an anti-microbial agent.

27. The pad of claim 21, wherein the substrate is fabricated from paperboard, polystyrene paper, or closed-cell foam board.

28. The pad of claim 21, wherein the first outer surface, the second outer surface, or both are shaped as a star or a heart.

29. The pad of claim 18, wherein the pad is substantially homogenous in composition.

30. The pad of claim 29, wherein the pad is fabricated from a natural or synthetic sponge material or a closed-cell foam.

31. The pad of claim 29, wherein the pad comprises an anti-microbial agent.

32. A method of brushing teeth using a toothbrush, the toothbrush having an elongated shaft having a proximal end defining a handle, and a distal end, with a plurality of bristles at the distal end, and the method, comprising:
sliding the shaft of the toothbrush through a through-opening in a pad, the pad comprising an outer circumference and an interior through-opening for removably and frictionally receiving the shaft of the toothbrush, and the pad being fabricated at least partially from an absorbent material;
brushing one's teeth with the toothbrush, and with the pad disposed over the shaft of the toothbrush; and
using the absorbent pad to capture water and oral fluids while brushing one's teeth.

33. The method of claim 32, further comprising:
resting the toothbrush onto a surface such that the proximal end of the toothbrush and the circumference of the pad rest on the surface but the bristles are suspended above the surface.

34. The method of claim 32, wherein the pad is further fabricated from an elastic material adjacent the through-opening.

35. The method of claim 32, wherein the pad comprises:
a substrate having a first density;
a first outer surface on a first side of the substrate having a second density; and
a second outer surface on a second opposing side of the substrate also having a second density.

36. The method of claim 35, wherein the first and second outer surfaces are fabricated substantially from a cellulosic material.

37. The method of claim 35, wherein the first and second outer surfaces are fabricated substantially from a non-woven airlaid material.

38. The method of claim 35, wherein the first and second outer surfaces comprise an anti-microbial agent.

39. The method of claim 35, wherein the substrate is fabricated from paperboard, polystyrene paper, or closed-cell foam board.

40. The method of claim 32, wherein the pad is substantially homogenous in composition.

41. The method of claim 40, wherein the pad is fabricated from a natural or synthetic sponge material or a closed-cell foam.

42. The method of claim 32, wherein the pad comprises an anti-microbial agent.

43. The method of claim 32, wherein the pad is shaped as a star or a heart.
